(19) United States
(12) Patent Application Publication
(10) Pub. No.: US 2026/0166834 A1
(43) Pub. Date: Jun. 18, 2026

(54) PUNCHING PROCESSING CONTROL METHOD

(71) Applicant: Panasonic Intellectual Property Management Co., Ltd., Osaka (JP)

(72) Inventors: MITSUO SAITOH, Osaka (JP); NAOKI NOJIRI, Osaka (JP); FUMINORI TAKAMI, Osaka (JP); HIDEAKI HAMADA, Hyogo (JP)

(21) Appl. No.: 19/534,848

(22) Filed: Feb. 10, 2026

Related U.S. Application Data
(63) Continuation of application No. PCT/JP2024/035387, filed on Oct. 3, 2024.

(30) Foreign Application Priority Data
Nov. 2, 2023 (JP) 2023-188658

(51) Int. Cl. B30B 15/26; B21D 28/00

(52) U.S. Cl. CPC B30B 15/26; B21D 28/00

(57) ABSTRACT

A punching processing control method is configured to control a processing state of a punching device that repeatedly performs punching processing of punching workpiece (33) placed on die (32) with punch (31), the punching processing control method including: calculating work (62) of a punching load in a position section based on punching load curve (51) indicating a relationship between a load of the punch and a position of the punch, the position section including a load at a time of punching the workpiece; calculating impulse (61) of the punching load in a time section based on punching load curve (51) indicating a relationship between a load of the punch and a time, the time section including the load at the time of punching the workpiece; and determining a punching speed based on the work of the punching load and the impulse of the punching load.

### TECHNICAL FIELD

The present disclosure relates to a punching processing control method.

### BACKGROUND ART

Tools used in machine tools wear due to repeated use to deteriorate machining accuracy of workpieces. When a tool cannot maintain its predetermined machining accuracy, the tool reaches its lifetime. To grasp the lifetime of a tool and take measures such as replacing the tool with a new tool before the tool reaches its lifetime, a technique for extending a lifetime of a tool has been studied.

PTL 1 discloses a case of using a pressing machine as a machine tool, in which the pressing machine configured to perform a repeated operation performs steps of first measuring pressure applied to a slide of the press machine, calculating a pressure reduction rate from a temporal change of the pressure, and determining whether punching has been performed on a workpiece in one shot.

Additionally, a punching processing control method is disclosed in which when the punching having not been performed on the workpiece is estimated by measuring a slide position of the pressing machine to calculate operation speed of the pressing machine from position information on the slide, a lower limit position of the slide is controlled by calculating a speed switching position of a next shot from the measured punching speed and the position information on the slide.

### CITATION LIST

### Patent Literature

PTL 1: Japanese Patent Publication No. 3775900

### SUMMARY OF THE INVENTION

The punching processing control method described in PTL 1 is performed to only control the lower limit position based on the punching speed and the punching position, and does not particularly mention which parameter is selected as an input and how to actually control the parameter to control the punching speed. Thus, there is still room for improvement in extending a tool lifetime of a die.

For this reason, the present disclosure provides a punching processing control method capable of extending a tool lifetime of a die.

A punching processing control method according to an aspect of the present disclosure is configured to control a processing state of a punching device that repeatedly performs punching processing of punching a workpiece placed on a die with a punch, the punching processing control method including the steps of: calculating work of a punching load in a position section based on a punching load curve between a load of the punch and a position of the punch, the position section including a load at the time of punching the workpiece; calculating an impulse of the punching load in a time section based on a punching load curve between a load of the punch and a time, the time section including the load at the time of punching the workpiece; and determining a punching speed based on the work of the punching load and the impulse of the punching load.

The present disclosure enables providing a punching processing control method capable of performing punching under optimum conditions for reducing a load applied to a tool by determining punching speed using the work of the punching load and the impulse of the punching load during the punching processing, thereby suppressing progress of wear of a side surface part of a punch to extend a tool lifetime of a die.

### BRIEF DESCRIPTION OF THE DRAWINGS

FIG. 1A is a schematic view illustrating a step of punching a workpiece with a machine tool.

FIG. 1B is a schematic view illustrating a step of punching the workpiece with the machine tool.

FIG. 1C is a schematic view illustrating a step of punching the workpiece with the machine tool.

FIG. 1D is a schematic view illustrating a step of punching the workpiece with the machine tool.

FIG. 2A is a schematic view illustrating a state of wear of a punch.

FIG. 2B is a schematic view illustrating a state of wear of the punch.

FIG. 3 is a block diagram illustrating a punching processing control device according to the present disclosure.

FIG. 4A is a graph illustrating a temporal change in a load applied to a punch during punching.

FIG. 4B is a graph illustrating a positional change of the load applied to the punch during the punching.

FIG. 5 is a flowchart for determining an estimated value to be controlled by a control value estimation model according to the present disclosure.

FIG. 6A is a diagram of a tool on which minute chipping has occurred.

FIG. 6B is a graph of a load curve when the minute chipping has occurred.

FIG. 7A is a graph of change (time axis) in a load curve generally observed.

FIG. 7B is a graph of change (position axis) in a load curve generally observed.

FIG. 7C is a graph of change in a load curve (time axis) according to an exemplary embodiment of the present disclosure.

FIG. 7D is a graph of change in a load curve (position axis) according to an exemplary embodiment of the present disclosure.

FIG. 8A is a schematic diagram illustrating a lateral force applied to a punch.

FIG. 8B is a schematic diagram illustrating the lateral force applied to the punch.

### DESCRIPTION OF EMBODIMENT

### Background of the Present Disclosure

A tool used in a machine tool is worn by repeating processing, and a load waveform obtained by measuring a load applied to the tool gradually changes with tool wear.

In general, when the tool comes into contact with a workpiece, the workpiece is processed (e.g., cut) by a shear force or a breaking force. Then, the tool receives a reaction force to cause an edge part of the tool to gradually wear.

Unfortunately, actual sites often experience a phenomenon of reduction of a lifetime of a tool due to progress of wear of the tool as a result of applying an excessive load to the tool more than usual when a remaining material part remains on an workpiece having been cut and causes a state in which the tool and the remaining material part physically interfere with each other to cause not only wear of the edge part of the tool but also wear of the side surface part of the tool to progress, for example.

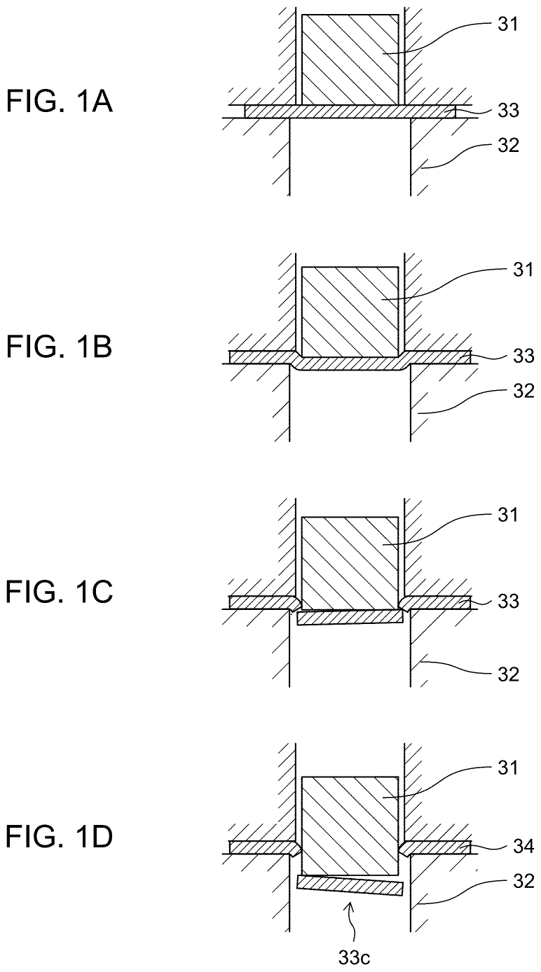

FIGS. 1A to 1D are each a schematic view illustrating a step of performing punching processing on workpiece 33 with punch 31 and die 32 as tools in a die that is installed in a machine tool.

When the processing is started, punch 31 descends and punch 31 comes into contact with workpiece 33 (FIG. 1A).

Next, punch 31 starts punching processing against workpiece 33 (FIG. 1B).

When punch 31 further descends, workpiece 33 is cut (FIG. 1C).

After workpiece 33 is punched out, workpiece 33 is separated into punched out part 33c after cutting and remaining material part 34, and punched out part 33c falls downward.

Meanwhile, physical interference occurs between punch 31 and remaining material part 34 of workpiece 33 for a while after workpiece 33 is punched out, and thus a load may be continuously applied to punch 31. For example, when remaining material part 34 of workpiece 33 is drawn between punch 31 and die 32 (FIG. 1D), punch 31 and remaining material part 34 may interfere with each other.

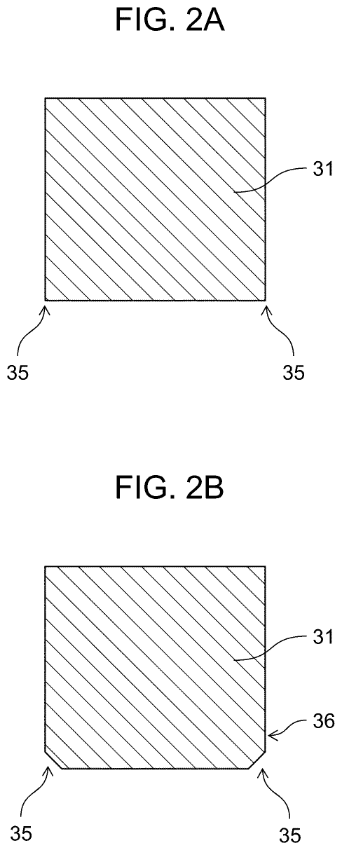

With reference to FIGS. 2A to 2B, a difference in a place where wear of punch 31 progresses will be described. When processing is performed on workpiece 33 with a lower part of punch 31 in FIG. 2A, wear mainly progresses at edge part 35 in the lower part of punch 31. Although the wear generally progresses forming a C-surface or an R-surface on edge part 35 as illustrated in FIG. 2B, interference between punch 31 and remaining material part 34 is likely to cause a phenomenon in which wear of side surface part 36 also gradually progresses to accelerate progress of wear of edge part 35 due to the wear of side surface part 36, thereby resulting in deterioration of a tool lifetime.

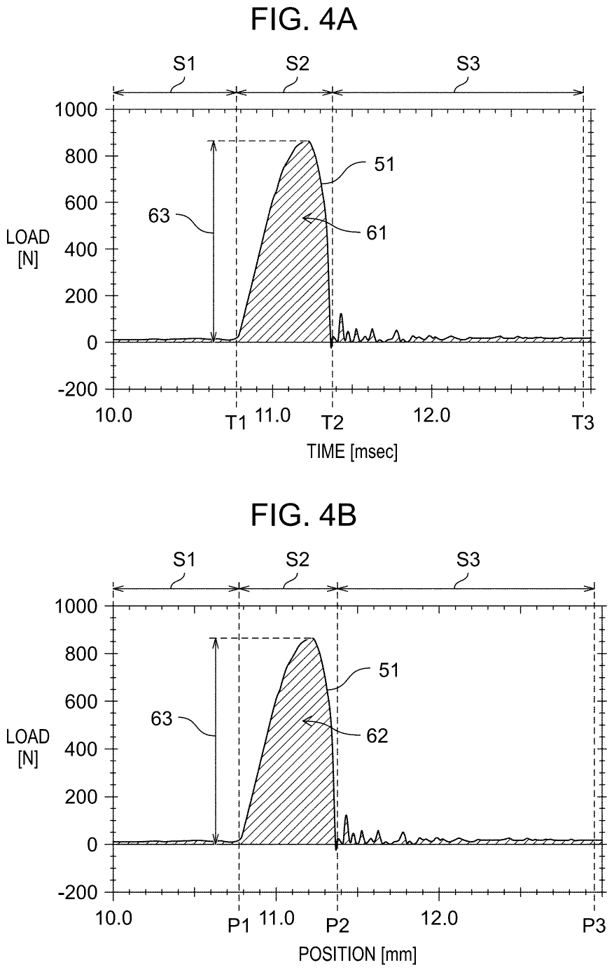

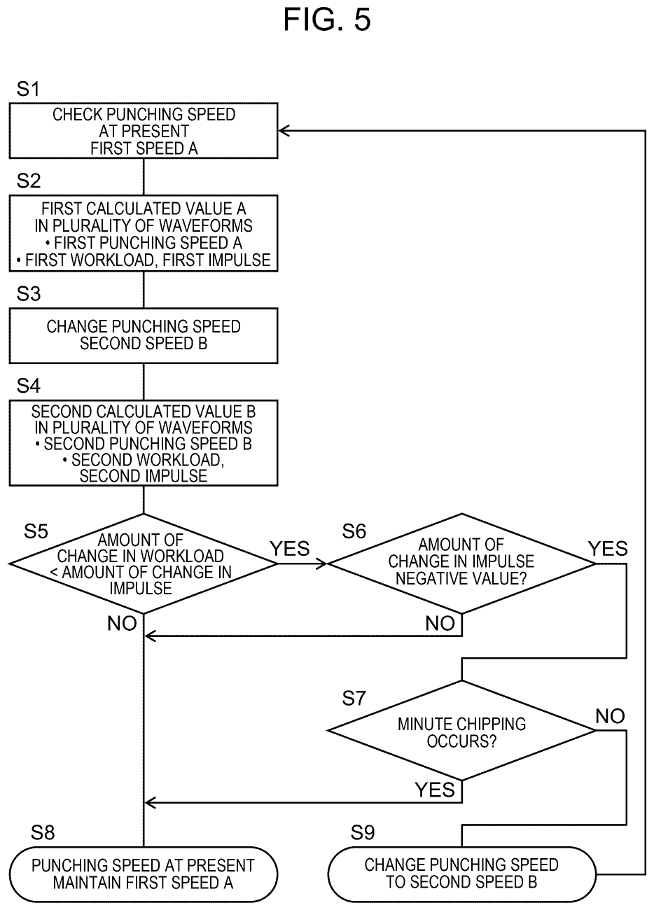

The present inventors have used information on a load applied to a tool to find a relationship between change in calculated values obtained from the load and progress of wear. Specifically, the present inventors have found suppression of not only progress of wear of a side surface part of a punch but also deterioration of a tool lifetime by controlling punching speed to an optimum numerical value among punching conditions based on the calculated values obtained from the load, thereby having reached the following disclosure. Here, the calculated values obtained from the load are work 62 of a punching load and impulse 61 of the punching load. Work 62 of the punching load is calculated from punching load curve 51 (see FIG. 4B) indicating a relationship between a load and a position of punch 31. Specifically, work 62 of the punching load is an integral value of punching load curve 51 in a position section including a load at the time of punching workpiece 33. Impulse 61 of the punching load is calculated from punching load curve 51 (see FIG. 4A) indicating a relationship between a load of punch 31 and time. Specifically, impulse 61 of the punching load is an integral value of punching load curve 51 in a time section including the load at the time of punching workpiece 33. The relationship between change in calculated values obtained from the load and progress of wear means that the progress of wear of punch 31 is suppressed when the punching speed increases and impulse 61 decreases even with work 62 without change.

Physical interference between punch 31 and remaining material part 34 of the workpiece is caused by various disturbance factors. Examples of the disturbance factors include a narrow clearance between punch 31 and die 32, and processing performed in a mode in which cutting is performed causing a tear while breaking force is dominant. For example, as the wear of punch 31 or die 32 progresses to some extent, a cutting mode can transition from a mode of cutting while shearing force is dominant to a mode of cutting like tearing off while breaking force is dominant. Alternatively, when workpiece 33 contains a material having high ductility, the cutting mode is likely to be a mode in which cutting is performed while the breaking force is dominant regardless of progress of wear of punch 31. Examples of the material having high ductility include a metal material, a resin material, and a composite material of the metal material and the resin material. Examples of the metal material having high ductility include gold, silver, platinum, iron (pure iron and low-carbon steel), stainless steel (especially austenitic stainless steel), nickel, copper, aluminum, zinc, tin, lead, titanium, magnesium, and Inconel (a trademark of a nickel-based superalloy, and the trade name of Special Metals Corporation that is formerly International Nickel Company).

Exemplary embodiments of the present disclosure will be described in detail below with reference to the drawings as appropriate. Unnecessary detailed description may not be described. For example, a detailed description of well-known matters, and a duplicate description of substantially identical configurations may not be provided. This is to avoid an unnecessarily redundant description below and to facilitate understanding of a person skilled in the art. The inventors provide the attached drawings and the following description for a person skilled in the art to fully understand the present disclosure, and do not intend to limit the subject matter described in the scope of claims with the drawings and the description.

### EXEMPLARY EMBODIMENT

### [General Configuration]

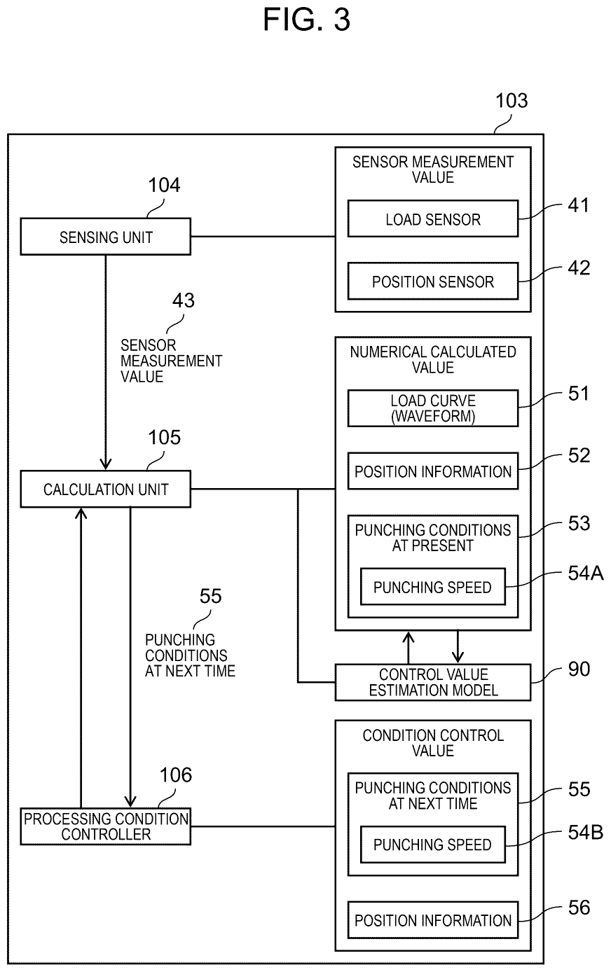

FIG. 3 is a block diagram illustrating punching processing control device 103 according to an exemplary embodiment.

The punching processing control device 103 performs a punching processing control method for controlling a processing state of a punching device that repeatedly performs punching processing of punching workpiece 33 placed on die 32 with punch 31.

Punching processing control device 103 includes a sensing unit 104, arithmetic unit 105, and a processing condition controller 106, which are connected to be able to communicate with each other in a wired or wireless manner. The communication can be performed by using a public line such as the Internet and/or a dedicated line. Each unit may be installed in an identical factory or in two or more sites, or may be installed for each machine tool.

Sensing unit 104 includes load sensor 41 attached to punch 31 or die 32 to measure a load applied to punch 31 and die 32 with high sensitivity as load curve (waveform) 51. Position sensor 42 is attached to at least one of a slide and a bolster of a punching device of a machine tool, for example, and a plate (a die plate, a stripper plate, or the like) of a die to measure position information 52, which corresponds to an operation position of punch 31, with high sensitivity. Sensor measurement values 43 such as measured load curve (waveform) 51 and the data on position information 52 are transmitted to arithmetic unit 105.

Arithmetic unit 105 acquires load curve 51 and position information 52, which are sensor measurement values 43, and punching conditions 53 at present (that is, before punching speed change determination) acquired from the machine tool to perform numerical calculation along control value estimation model 90 (described later), which has been preset, based on acquired sensor measurement values 43 and punching conditions 53.

Load curve 51 indicates a temporal change or a positional change of the load applied to punch 31 and acquired by load sensor 41. Here, load curve 51 indicating a relationship between the load and time or position will be described with reference to FIGS. 4A to 4B and FIGS. 1A to 1D. FIG. 4A is a graph illustrating a temporal change of a load applied to punch 31 during punching processing using a machine tool.

When the processing is started, punch 31 descends and punch 31 comes into contact with workpiece 33 (FIG. 1A). The graph of FIG. 4A indicates time T1 at which punch 31 comes into contact with workpiece 33. As illustrated in the graph of FIG. 4A, almost no load is applied to punch 31 until punch 31 comes into contact with workpiece 33 (section S1 in FIG. 4A).

When punch 31 starts punching workpiece 33 (FIG. 1B), a load on punch 31 rapidly increases as illustrated in section S2 of the graph of FIG. 4A. The graph of FIG. 4A indicates time T2 at which workpiece 33 is cut by punch 31 (FIG. 1C). When workpiece 33 is cut, the load applied to punch 31 decreases to near zero. This is because resistance to punch 31 is eliminated by punching out workpiece 33.

For a while after workpiece 33 is punched out (section S3 in the graph of FIG. 4A), an extra load is applied to punch 31 due to disturbance factors such as interference between punch 31 and remaining material part 34.

Cutting in actual processing is not always performed while punch 31 and workpiece 33 are kept vertical. Thus, when punching is performed while punch 31 is slightly inclined, an excessive load on punch 31 due to disturbance factors such as interference between punch 31 and remaining material part 34 may also be included in section S2 of the graph of FIG. 4A.

Although FIG. 4A illustrates only the load curve with the horizontal axis indicating the temporal change, as illustrated in FIG. 4B, even the horizontal axis indicating positional change corresponding to an operation position of punch 31 based on position information 52 enables obtaining a load waveform similar to that in FIG. 4A as described below. FIG. 4B is a graph illustrating a positional change of the load applied to punch 31 during the punching processing using the machine tool.

When the processing is started, punch 31 descends and punch 31 comes into contact with workpiece 33 (FIG. 1A). The graph of FIG. 4B indicates position P1 at which punch 31 comes into contact with workpiece 33. As illustrated in the graph of FIG. 4B, almost no load is applied to punch 31 until punch 31 comes into contact with workpiece 33 (section S1 in FIG. 4B).

When punch 31 starts punching workpiece 33 (FIG. 1B), a load on punch 31 rapidly increases as illustrated in section S2 of the graph of FIG. 4B. The graph of FIG. 4B indicates position P2 at which workpiece 33 is cut by punch 31 (FIG. 1C). When workpiece 33 is cut, the load applied to punch 31 decreases to near zero. This is because resistance to punch 31 is eliminated by punching out workpiece 33.

For a while after workpiece 33 is punched out (section S3 in the graph of FIG. 4B), an extra load is applied to punch 31 due to disturbance factors such as interference between punch 31 and remaining material part 34.

Cutting in actual processing is not always performed while punch 31 and workpiece 33 are kept vertical. Thus, when punching is performed while punch 31 is slightly inclined, an excessive load on punch 31 due to disturbance factors such as interference between punch 31 and remaining material part 34 may also be included in section S2 of the graph of FIG. 4B.

Arithmetic unit 105 calculates various operation values from load curve 51. That is, arithmetic unit 105 can calculate an integral value (area) of load curve 51 in section S2 and section S3 in each of FIGS. 4A and 4B, and can calculate impulse 61 of the load as the integral value for FIG. 4A with the horizontal axis indicating the temporal change, load work 62 as the integral value for FIG. 4B with the horizontal axis indicating the positional change, peak load 63 as the maximum value of the load in section S2 of each of FIGS. 4A and 4B, and the like.

Arithmetic unit 105 can calculate also punching speed 54A for workpiece 33 from time information and position information 52.

Additionally, arithmetic unit 105 can calculate punching conditions 55 at the next time (that is, after the punching speed change determination) along control value estimation model 90 (described later) and based on previous arithmetic results and punching conditions 53 at present (that is, before the punching speed change determination).

Data on punching conditions 55 at the next time, which has been calculated, is transmitted from arithmetic unit 105 to processing condition controller 106.

Processing condition controller 106 can control the processing conditions of the machine tool based on punching conditions 55 at the next time (that is, after the punching speed change determination). For example, processing condition controller 106 can increase and reduce punching speed 54B by controlling a servomotor of the machine tool.

An example is described here in which the integrated value (area) of load curve 51 in section S2 and section S3 of each of FIGS. 4A and 4B is calculated by arithmetic unit 105. Alternatively, arithmetic unit 105 may select only one of section S2 and section S3 of each of FIGS. 4A and 4B, and then can capture the amount of change in impulse 61 of a desired load and work 62 of the load even in an integrated value (area) of load curve 51 in section S2 or section S3.

### [Control Value Estimation Model]

FIG. 5 illustrates a flow in which arithmetic unit 105 determines an estimated value to be controlled by control value estimation model 90. This model 90 enables arithmetic unit 105 to determine a prediction value by bidirectionally transferring information between arithmetic unit 105 and processing condition controller 106.

With reference to FIG. 5, a method will be described in which arithmetic unit 105 determines an estimated value of punching speed as an example of an estimated value to be controlled.

In step S1, arithmetic unit 105 first acquires punching conditions 53 at present (that is, before the punching speed change determination) from the machine tool, and checks punching speed (first speed A) at present (that is, before the punching speed change determination), and then calculates first operation value A using a plurality of load waveforms of a load curve.

In next step S2, arithmetic unit 105 calculates first impulse 61 of a load and first work 62 of the load as first operation value A. At this time, arithmetic unit 105 preferably calculates an average value of impulses and an average value of works for the latest 10 shots to 100 shots as the first impulse and the first work, respectively. Too small or too large in number of shots is not preferable because an average value for several shots less than 10 shots is likely to vary due to influence of various disturbances, and a load waveform changes from moment to moment depending on the amount of wear of punch 31. Arithmetic unit 105 preferably selects a latest load waveform in consideration of influence of the amount of wear of punch 31 as described above.

In next step S3, processing condition controller 106 changes the punching speed from first speed A to second speed B to continue the punching. At this time, the change from first speed A to second speed B larger than first speed A is preferable.

In next step S4, arithmetic unit 105 calculates second operation value B at second speed B. As with first operation value A, arithmetic unit 105 calculates second impulse 61 of a load and second work 62 of the load as second operation value B. Arithmetic unit 105 preferably calculates an average value of impulses and an average value of works for shots similar in number to those for the first arithmetic value A, as second impulse 61 and second work 62, respectively.

In next step S5, arithmetic unit 105 calculates the amount of change of the average value of impulse 61 of the load and the amount of change of the average value of work 62 of the load, each change being caused by the change from first speed A to second speed B. Arithmetic unit 105 further compares an absolute value of the amount of change of the average value of impulse 61 of the load with an absolute value of the amount of change of the average value of work 62 of the load. When arithmetic unit 105 determines that Expression (1) below is satisfied, processing proceeds to the next determination step S6.

Amount of change in work 62 (absolute value)<amount of change in impulse 61 (absolute value) (1)

In contrast, when arithmetic unit 105 determines that Expression (1) is not satisfied, arithmetic unit 105 in step S8 determines to maintain first speed A that is punching speed at present (that is, before the punching speed change determination).

In next step S6, arithmetic unit 105 checks whether the amount of change of the average value of impulse 61 of the load is a negative value. When arithmetic unit 105 determines that the amount is a negative value, the processing proceeds to next determination step S7. In contrast, when arithmetic unit 105 determines that the amount is not a negative value, arithmetic unit 105 in step S8 determines to maintain first speed A that is punching speed at present (that is, before the punching speed change determination).

In step S6, not only the amount of change of the average value of impulse 61 of the load, the amount being a negative value, but also the amount of change of the average value of impulse 61, the amount satisfying a relationship of Expression below, is more preferable.

(Second speed B/first speed A)≤(impulse 61 at second speed B/impulse 61 at first speed A) (2)

This is because the impulse may change to the same extent as a speed ratio on the premise that a peak load obtained from the load curve does not substantially change even when speed is changed.

In next step S7, arithmetic unit 105 determines whether minute chipping has occurred in punch 31 and die 32. Whether the minute chipping has occurred can be detected by pattern matching with a preset (or stored) reference waveform, or by threshold determination of a re-rising value of the load (a peak immediately after punching) after time T2 and position P2 immediately after punching, at which a load value once largely decreases to near zero. When arithmetic unit 105 determines that the minute chipping has occurred, an excessive load may be applied to a tool, thus being determined that the punching speed is not appropriate. Thus, arithmetic unit 105 determines to maintain first speed A that is the punching speed at present (that is, before the punching speed change determination).

In this step S7, when arithmetic unit 105 can determine that no minute chipping has occurred, arithmetic unit 105 can determine that the punching speed is preferably changed to second speed B.

Arithmetic unit 105 transmits a value of second speed B of the punching speed to processing condition controller 106 as next punching conditions 55, and processing condition controller 106 changes the punching conditions to second speed B of the punching speed.

A determination flow as described above enables not only determining the punching speed as an example of an estimated value to be controlled, but also changing the punching conditions depending on a processing state.

When stability of punching such as no occurrence of minute chipping is checked after a certain number of shots is further performed, second speed B of the punching speed is changed to the punching speed at present (that is, before the punching speed change determination), thereby repeating the determination flow in FIG. 5.

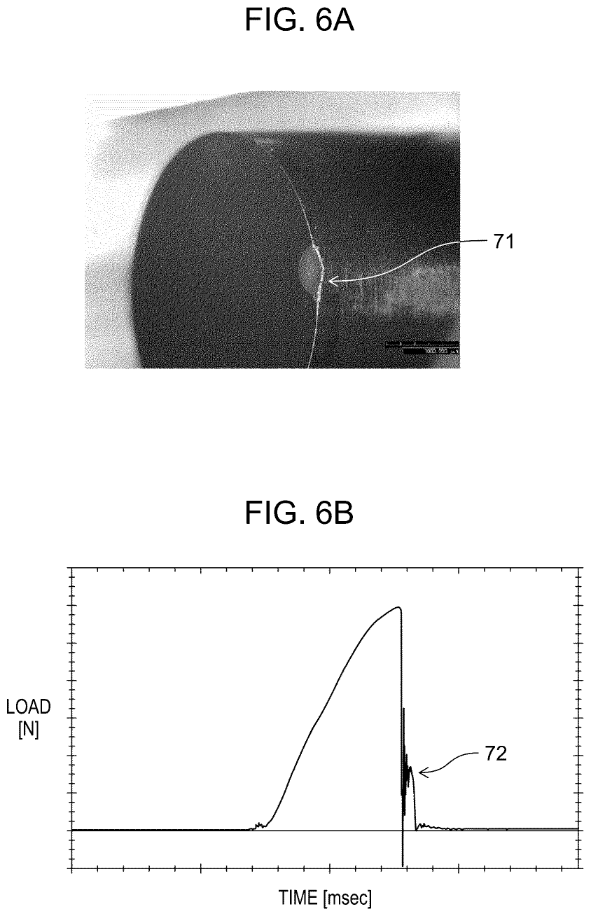

Here, FIGS. 6A to 6B illustrate characteristics of load curve 51 when the minute chipping has occurred.

FIG. 6A is an enlarged image of an edge part of punch 31 on which minute chipping 71 has occurred. FIG. 6B illustrates a load curve at this time, in which an appearance of minute peak 72 of a chipping part can be checked. When minute chipping 71 has occurred, punching is physically delayed in only the part. Thus, the minute chipping appears in a load curve in the form of minute peak 72.

As described above, when arithmetic unit 105 captures the characteristics of the load waveform, arithmetic unit 105 can determine whether minute chipping has occurred.

The punching processing control method described above enables performing punching processing under optimal conditions for reducing a load applied to a tool by controlling a processing state by determining punching speed using change in work of a punching load and change in an impulse of the punching load during the punching processing, thereby enabling progress of wear of a side surface part of punch 31 to be suppressed to extend a tool lifetime of a die.

### [Estimation Mechanism]

Here, a mechanism will be described in which effect as described above is obtained by changing the punching speed.

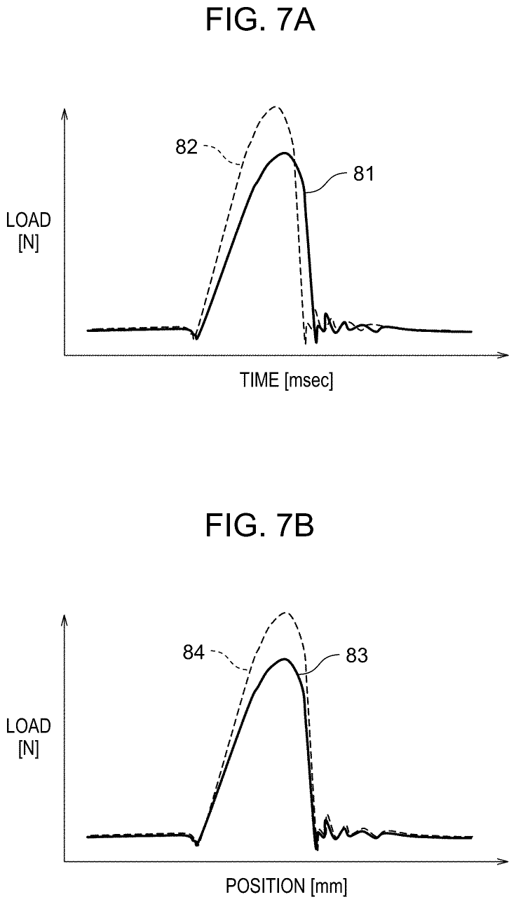

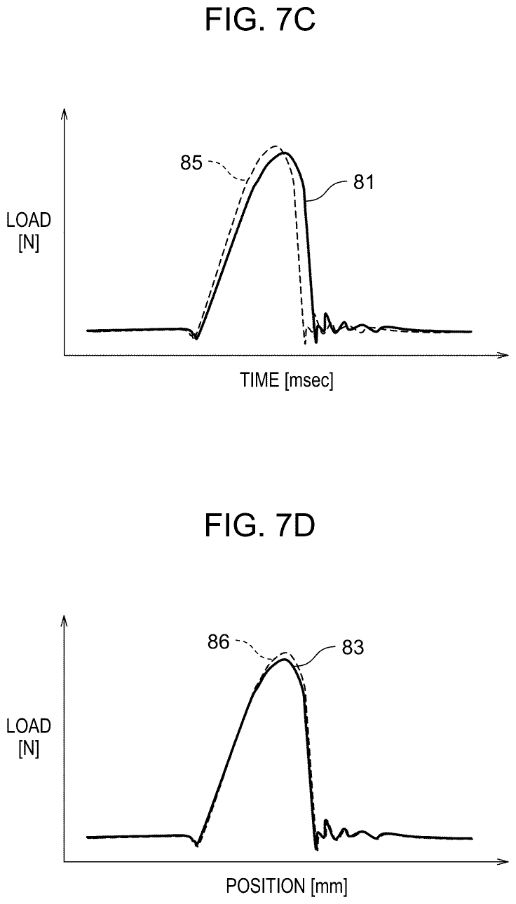

FIGS. 7A to 7D each illustrate a load curve when the punching speed is changed. Among them, FIGS. 7A to 7B each show a graph of change in a load curve (time axis and position axis) generally seen, and FIGS. 7C to 7D each show a graph of change in a load curve (time axis and position axis) according to an exemplary embodiment of the present disclosure.

FIG. 7A illustrates the change in the load curve that is generally seen when the punching speed is changed, and indicates load waveform 81 before the change in the punching speed with a solid line, and load waveform 82 after the change in the punching speed with a broken line. The punching speed after the change is increased to more than that before the change. FIG. 7A has the horizontal axis representing time, so that an integral value calculated in the load waveform becomes an impulse.

FIG. 7B illustrates the change in the load curve that is generally seen when the punching speed is changed, and indicates load waveform 83 before the change in the punching speed with a solid line, and load waveform 84 after the change in the punching speed with a broken line. The punching speed after the change is increased to more than that before the change. FIG. 7B has the horizontal axis representing position, so that an integral value calculated in the load waveform becomes work.

In general, as the punching speed is increased, impact force generated between punch 31 and workpiece 33 increases. Thus, a load after the change in the punching speed increases to more than that before the change. That is, the load waveform greatly increases on the vertical axis. In contrast, when the horizontal axis is the time axis, the load waveform decreases in the horizontal axis direction by an increase in the punching speed. When the horizontal axis is the position axis, a distance over which a load is applied by punching does not change even when the punching speed increases. Thus, the load waveform does not change in the horizontal axis direction.

As a result of passing through such a mechanism, work 62 becomes equal in the amount of change (absolute value) to impulse 61, or impulse 61 increases in the amount of change (absolute value) to more than the amount of change (absolute value) in work 62, depending on the amount of increase in a load. The amount of change in work 62 and the amount of change in impulse 61 after the change in the punching speed increase to more than those before the change. This is because the load in the vertical axis greatly increases.

In contrast, FIG. 7C illustrates a change in the load curve according to the exemplary embodiment of the present disclosure when the punching speed is changed, and indicates load waveform 81 before the change in the punching speed with a solid line and load waveform 85 after the change in the punching speed according to the exemplary embodiment of the present disclosure with a broken line. The punching speed after the change is increased to more than that before the change. FIG. 7C has the horizontal axis representing time, so that an integral value calculated in the load waveform becomes an impulse.

FIG. 7D illustrates a change in the load curve according to the exemplary embodiment of the present disclosure when the punching speed is changed, and indicates load waveform 83 before the change in the punching speed with a solid line, and load waveform 86 after the change in the punching speed according to the exemplary embodiment of the present disclosure with a broken line. The punching speed after the change is increased to more than that before the change. FIG. 7D has the horizontal axis representing position, so that an integral value calculated in the load waveform becomes work.

In general, as the punching speed is increased, the impact force generated between punch 31 and workpiece 33 increases. However, when a decrease in lateral force is superior to an increase in the impact force (in other words, changing the punching speed causes an effect of reducing lateral force 39 as will be described later), the load may not change significantly even when the punching speed is increased. That is, the load waveform may hardly change on the vertical axis. In contrast, when the horizontal axis is the time axis, the punch descends faster as the punching speed increases. Thus, the load waveform narrows in the horizontal axis direction. When the horizontal axis is the position axis, a distance over which a load is applied by punching does not change even when the punching speed increases. Thus, the load waveform does not change in the horizontal axis direction.

As a result of passing through such a mechanism, impulse 61 increases in the amount of change (absolute value) to more than the amount of change (absolute value) in work 62, depending on the amount of increase in a load. The amount of change in work 62 and the amount of change in impulse 61 after the change in the punching speed decrease to less than those before the change. This is because a change on the horizontal axis is likely to be reflected while the load on the vertical axis hardly changes.

In general, a workpiece may often vary in thickness at a production site, so that a change due to the variation in the thickness of the workpiece needs to be eliminated.

When the workpiece varies in thickness, a load curve indicated with the horizontal axis of the position axis shows a value on the horizontal axis that increases or decreases substantially in proportion to the thickness of the workpiece, and the amount of change (absolute value) of work 62 also increases or decreases. In contrast, a load curve indicated with the horizontal axis of the time axis shows a value on the horizontal axis that increases or decreases substantially in proportion to the thickness of the workpiece, and the amount of change (absolute value) of impulse 61 also increases or decreases.

In this situation, the amount of change (absolute value) of work 62 is substantially equal to the amount of change (absolute value) of impulse 61, so that the relationship of Expression (1) does not hold. In other words, when the change in the work is compared with the change in the impulse instead of considering only the change in the impulse, optimum conditions for reducing the load applied to the tool can be found by eliminating the change due to the variation in the thickness of the workpiece.

As described above, the estimation mechanism illustrated in FIGS. 7C to 7D enables extending a tool lifetime of the die by finding the optimum conditions for reducing the load applied to the tool using control value estimation model 90 illustrated in FIG. 5.

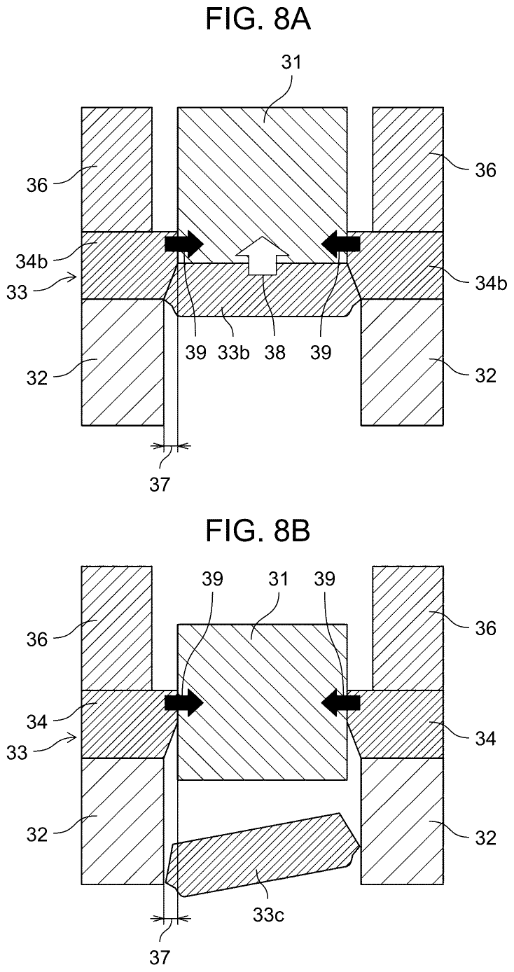

Here, the lateral force applied to punch 31 will be described with reference to FIGS. 8A to 8B. In a process of punching workpiece 33 with punch 31, punch 31 receives reaction force 38 in a punching direction from workpiece 33b during processing deformation, and receives lateral force 39 from remaining material part 34b during processing on a side surface of punch 31. Remaining material part 34b during processing is pressed and fixed in the vertical direction by die 32 and stripper 36, so that lateral force 39 from remaining material part 34b during processing is not negligible.

As illustrated in FIG. 8B, the side surface of punch 31 continues to receive lateral force 39 from remaining material part 34 even in a process after workpiece 33 is cut. Although a magnitude of lateral force 39 is reduced to less than that during the punching processing, lateral force 39 is continuously received.

Thus, the load applied to punch 31 is the sum of reaction force 38 in the punching direction and lateral force 39, and the impact force generated between punch 31 and workpiece 33 is included in reaction force 38 in the punching direction. As described above, increasing the punching speed causes an effect of increasing the impact force. Meanwhile, rapid lowering of punch 31 is considered to cause an effect of reducing a contact force or a coefficient of dynamic friction with remaining material part 34b during processing or remaining material part 34, so that a balance between the impact force and lateral force 39 is considered to greatly change depending on conditions under which workpiece 33 is punched out.

As conditions for causing the change in the load curve according to the exemplary embodiment of the present disclosure illustrated in FIGS. 7C to 7D, clearance 37 between punch 31 and die 32 is preferably narrow. Narrow clearance 37 increases a ratio of lateral force 39 to reaction force 38 in the punching direction, so that effect of alleviating lateral force 39 is considered to increase by changing the punching speed. When a tool having been fabricated is considered to have a finished dimension with a tolerance of ±3 μm, and a dimension with an accumulated error when a die is manually assembled and a dimension caused by distortion when the die is mounted on a machine tool are considered to have a tolerance of about ±12 μm, for example, clearance 37 is practically considered to be approximately 15 μm or less as conditions in which clearance 37 is narrow.

To satisfy conditions for causing the change in the load curve according to the exemplary embodiment of the present disclosure illustrated in FIGS. 7C to 7D, workpiece 33 is preferably made of a material selected from among a metal material with high ductility, a resin material, and a composite material of the metal material and the resin material, the metal material being typified by gold, silver, platinum, iron (pure iron and low-carbon steel), stainless steel (particularly austenitic stainless steel), nickel, copper, aluminum, zinc, tin, lead, titanium, magnesium, or Inconel (a trademark of a nickel-based superalloy, and the trade name of Special Metals Corporation that is formerly International Nickel Company). As a material increases in ductility, the material is processed in a mode in which cutting is performed causing a tear while breaking force is dominant. Thus, the ratio of lateral force 39 to reaction force 38 in the punching direction is considered to increase.

As conditions for causing the change in the load curve according to the exemplary embodiment of the present disclosure illustrated in FIGS. 7C to 7D, punch 31 or die 32 is preferably in a state where wear has progressed to some extent. As the wear progresses, the material is processed in a mode in which cutting is performed causing a tear while breaking force is dominant. Thus, the ratio of lateral force 39 to reaction force 38 in the punching direction is considered to increase. In general, when the amount of wear of punch 31 or die 32 progresses to about 20 μm, burrs are often generated in workpiece 33, and when the amount of wear reaches about 20 μm, processing is considered to be often performed in a mode in which cutting is performed causing a tear.

### Effect

The exemplary embodiment described above enables providing a punching processing control method capable of performing punching processing under optimal conditions for reducing a load applied to a tool by controlling a processing state by determining punching speed using change in work of a punching load and change in an impulse of the punching load during the punching processing, thereby enabling progress of wear of a side surface part of punch 31 to be suppressed to further extend a tool lifetime of a die.

Appropriate combination of any exemplary embodiments or modifications among the various exemplary embodiments or modifications described above enables achieving effect of each of the exemplary embodiments or modifications. Additionally, combinations of exemplary embodiments, combinations of examples, or combinations of exemplary embodiments and examples are possible, and combinations of features in different exemplary embodiments or examples are also possible.

### INDUSTRIAL APPLICABILITY

The punching processing control method according to the present disclosure is widely applicable to extending a tool lifetime of a die in a processing device that performs processing such as cutting, bending, forging, or drawing.

### REFERENCE MARKS IN THE DRAWINGS

103 punching processing control device
104 sensing unit
105 arithmetic unit
106 processing condition controller
31 punch
32 die
33 workpiece
33b workpiece during processing deformation
33c punched out part
34 remaining material part
34b remaining material part during processing
35 side surface part
36 stripper
37 clearance
38 reaction force in punching direction
39 lateral force
41 load sensor
42 position sensor
43 sensor measurement value
51 load curve (waveform)
52 position information
53 punching conditions at present (that is, before punching speed change determination)
54A punching speed of punching conditions at present (that is, before punching speed change determination)
54B punching speed of next punching conditions
55 punching conditions
61 impulse of load
62 work of load
63 peak load
71 minute chipping
72 minute peak
81 load waveform before change in punching speed (time axis)
82 load waveform after change in punching speed (time axis)
83 load waveform before change in punching speed (position axis)
84 load waveform after change in punching speed (position axis)
85 load waveform after change in punching speed according to exemplary embodiment of present disclosure (time axis)
86 load waveform after change in punching speed according to exemplary embodiment of present disclosure (position axis)
90 control value prediction model

1. A punching processing control method for controlling a processing state of a punching device that repeatedly performs punching processing of punching a workpiece placed on a die with a punch, the punching processing control method comprising:
calculating work of a punching load in a position section based on a punching load curve indicating a relationship between a load of the punch and a position of the punch, the position section including the load at a time of punching the workpiece;
calculating an impulse of the punching load in a time section based on a punching load curve indicating a relationship between a load of the punch and a time, the time section including the load at the time of punching the workpiece; and
determining a punching speed based on the work of the punching load and the impulse of the punching load.

2. The punching processing control method according to claim 1, further comprising:
changing the punching speed from first speed determined in the determining the punching speed to second speed higher than the first speed after the determining the punching speed;
calculating an amount of change in the work of the punching load before and after the punching speed is changed to the second speed and an amount of change in the impulse of the punching load before and after the punching speed is changed to the second speed, and comparing the amount of change in the work of the punching load with the amount of change in the impulse of the punching load; and
determining a value of the punching speed to a value of the second speed after the change when the amount of change in the impulse of the punching load is larger than the amount of change in the work of the punching load.

3. The punching processing control method according to claim 1, further comprising:
changing the punching speed from first speed to second speed determined in the determining the punching speed after the determining the punching speed,
wherein the changing the punching speed from the first speed to the second speed includes determining a value of the punching speed to be a value of the second speed only when the amount of change in the impulse of the punching load is larger than the amount of change in the work of the punching load and the amount of change in the impulse of the punching load is a negative value in a case where conditions are changed such that the second speed is higher than the first speed.
